(19) United States
(12) Patent Application Publication
(10) Pub. No.: US 2017/0344315 A1
(43) Pub. Date: Nov. 30, 2017

(54) METHOD AND APPARATUS FOR CONTROLLING A POST-PRINT PROCESSING SYSTEM

(71) Applicant: MUELLER MARTINI HOLDING AG, Hergiswil (CH)

(72) Inventors: Alexander STRUB, Oberentfelden (CH); Andreas HESS, Strengelbach (CH); Christian SCHMID, Rothrist (CH)

(73) Assignee: MUELLER MARTINI HOLDING AG, Hergiswil (CH)

(21) Appl. No.: 15/607,946

(22) Filed: May 30, 2017

(30) Foreign Application Priority Data
May 30, 2016 (CH) 00691/16

(51) Int. Cl. G06F 3/12

(52) U.S. Cl. CPC G06F 3/1205; G06F 3/1286; G06F 3/1264; G06F 3/121; G06F 3/1234; G06F 3/1236

(57) ABSTRACT

A method and apparatus for controlling a post-print processing system for producing printed products. The system comprises a plurality of replaceable individual devices which are arranged one after another in a row and/or parallel and are connected to a joint control unit for adapting the system to successively following different production orders. The method includes supplying the joint control unit with information relating to the type and position of the individual devices in the post-print processing system and activating the individual devices based on the information. The information relating to the position of the individual devices is determined in the post-print processing system based on the position of the individual devices in a first data processing network comprising a ring circuit. The individual devices send out a data telegram corresponding to the position of the respective individual devices via a second data processing network to the joint control unit.

### CROSS-REFERENCE TO RELATED APPLICATION

Priority is claimed to Swiss Application No. CH 00691/16, filed May 30, 2016, the disclosure of which is incorporated herein by reference in its entirety.

### BACKGROUND OF THE INVENTION

The invention relates to a method and an apparatus for controlling a post-print processing system that is used for producing printed products, said apparatus comprising several replaceable individual devices which are arranged one after another in a row and/or parallel to each other for the adaptation to successively following, different production orders and which are connected to a joint, computer-based control unit, wherein the joint control unit is provided via a data processing network with information relating to the type of individual devices contained in the post-print processing system and their respective position within the post-print processing system and activates the individual devices on the basis of this information. The invention furthermore relates to a post-print processing system provided with such an apparatus.

Several successive operating steps are required for the further processing of printed products in a post-print processing system. The printed products or parts thereof in the process are differently conveyed, folded, trimmed, combined or otherwise processed at least partially, depending on the work order, that is to say, depending on the type, format and addressing of the printed products to be produced.

Whereas in the past each production order frequently involved large to extra-large editions of, in part, several thousand copies of the same printed products, the tendency nowadays is toward successively following production orders of different printed products in small series, up to the production of individual products. Accordingly, the devices of a post-print processing system must be adjusted for time and cost reasons as quickly as possible to the production of different printed products and/or must be exchanged for devices suitable for production of different printed products. However, at least with the replacement of devices the configuration of the post-print processing system changes. For an effective drive control of such a post-print processing system, its current configuration must be transmitted to the control unit, meaning the type of the installed individual devices as well as their respective position and/or sequence in the post-print processing system.

European patent document EP 1457847 A2 discloses respectively determining the type of device via an indicator and a control device connected to the indicators. The indicator in that case can be a plug, embodied individually for each device or having a number of identical pins which, depending on the device, can be admitted with a different voltage or current intensity. Alternative solutions are furthermore disclosed where the indicator generates a digital signal that is characteristic for the respective device and which is used itself, or its duration, for identifying the respective device. Finally, the indicator can also be a data carrier. An indicator is thus provided for each replaceable device which cooperates with the control unit via a separate cable connection or via a wireless connection. The control unit can be provided with information relating to the position where a specific device of the post-print processing system is located, either via additional sensors or a manual input by the machine operator. Owing to the plurality of the required components, a device of this type and the method realized therewith is relatively costly and time consuming. In addition, a manual position input is subject to errors.

German patent document DE 19752015 A1 discloses a method for the drive control of a post-print processing system embodied as a gathering and wire-stitching machine, wherein the individual devices of the gathering and wire-wire-stitching machine are respectively provided with an individual drive and a control unit connected thereto. The motors for the individual drive units can be controlled differently, depending on the work order. A field bus is used for the exchange of data and/or control signals, necessary between the control unit and the respective device. In this way, new devices or other devices can be integrated advantageously into the gathering and wire-stitching machine, without requiring additional cable connections. With this solution, the control unit can be provided with information on the position where a specific device of the post-print processing system is located and/or the sequence of the devices in the post-print processing system, also either via additional sensor technology or a new manual input by the machine operator. However, additional sensor technology is costly and time consuming and a manual input of the position is subject to errors.

### SUMMARY OF THE INVENTION

It is therefore an object of the present invention to develop a simple, cost-effective method not subject to errors and a corresponding apparatus for controlling replaceable individual devices, which are arranged one after another in a row and/or parallel, of a post-print processing system for adapting to different production orders, as well as a post-print processing system containing such a control apparatus.

The above and other objects are achieved according to the invention wherein according to one embodiment there is provided a method for controlling a post-print processing system for producing printed products, the system comprising a plurality of replaceable individual devices which are arranged one after another in a row and/or parallel and are connected to a joint control unit for adapting it to successively following different production orders, the method comprising: supplying the joint control unit with information relating to the type and position of the individual devices in the post-print processing system and activating the individual devices based on said information; determining the information relating to the position of the individual devices in the post-print processing system based on the position of the individual devices in a first data processing network, comprising a ring circuit; and sending out from the individual devices a data telegram corresponding to the position of the respective individual devices via a second data processing network to the joint control unit.

Thus, with the method according to the invention, information relating to the position of the individual devices in the post-print processing system is determined based on the position of the device in a first data processing network, embodied as ring circuit. A corresponding data telegram is transmitted for this via a second data processing network from each individual device to the joint, computer-based control device.

This type of position determination does not require cost-relevant additional electronic components for the sensor technology and no manual position input that is subject to errors. Rather, a technology known from the electronic field and the computer industry, for which several electronic components are hardwired in a ring circuit, is advantageously utilized for determining the respective position of an individual device in the post-print processing system. Surprisingly it has turned out that this type of wiring schema used until now for other purposes, can be used for determining the position of individual devices in a post-print processing system because of the fixedly predetermined sequence for the further data transmission. The ascertained information is then transmitted further via a conventional second data network to the joint control unit and, among other things, is evaluated therein for determining the position of the individual devices. A simple, cost-effective method which is not subject to errors is thus obtained for controlling a post-print processing system, intended for producing printed products and for determining the position of the individual devices in a post-print processing system, as well as to further transmit and process the information determined in this way.

According to one embodiment of the inventive method, the position occupied by the individual devices in the post-print processing system is determined in the joint control unit. Depending on the performance criteria of the individual electronic components, this central position determination represents an advantageous solution. In addition, a central position determination can also be advantageous for interconnecting additional devices in the post-print processing system.

According to one embodiment of the inventive method, information relating to a last individual device of the post-print processing system is transmitted via the first data processing network to the joint control unit. The individual devices are activated only after this information is received.

The joint control unit can thus check whether the information received via the first data processing network and relating to the last individual device coincides with the knowledge of the number of replaceable individual devices arranged in the post-processing system, which is obtained from the information received via the second data processing network. If not, corresponding measures can be taken, such as checking the individual devices and a check made by the machine operator of the joint control unit and the control apparatus for the two data networks. Since, following the receiving the information via the first data network, even the last individual device of the post-print processing system has been identified, it can furthermore be ensured that respective data telegrams for activating the individual devices are transmitted only after the identification of all replaceable individual devices currently installed in the post-print processing system. Accordingly, high quality as well as safety requirements can be met with this advantageous embodiment of the inventive method.

According to one embodiment of the inventive method, the information relating to a last individual device of the post-print processing system is branched off from the first data processing network, is transmitted further to the individual devices and is transmitted by the individual devices via the second data processing network to the joint control unit. If this information does not arrive from all individual devices in the joint control unit, corresponding malfunctions in the individual devices or interruptions in the signal transmission can advantageously be localized precisely by the joint control unit.

In accordance with a different embodiment of the inventive method, following the start-up of the post-print processing system and upon request from the joint control unit, the individual devices installed in the post-print processing system respectively send a first data telegram via the second data processing network to the joint control unit as identification for these devices. Following this, a first discrete signal is transmitted by the joint control unit via the first data processing network to a first individual device located at a first position in the first data processing network. The first individual device detects the first discrete signal and subsequently transmits via the second data processing network a second data telegram relating to the reception of the first discrete signal to the joint control unit. Based on the second data telegram, the joint control unit determines the position of the first individual device in the post-print processing system and then transmits a third data telegram to the first individual device. The first individual device identified in this way then generates a second discrete signal and transmits this signal via the first data processing network to a following individual device.

This process is repeated for all individual devices, arranged sequentially in a row, of the post-print processing system, wherein an additional discrete signal is respectively generated and is transmitted via the first data processing network to a successively following individual device of the post-print processing system. In the process, an individual device located in a last position in the first data processing network generates a last discrete signal, corresponding to the n^{th} position for this individual device, and transmits this last discrete signal via the first data processing network to the joint control unit. Once the last discrete signal is received and evaluated in the joint control unit, it triggers the actuation of the individual devices with additional data telegrams transmitted via the second data processing network.

This method represents a preferred, advantageous embodiment for determining the number n as well as the respective position of the individual devices arranged in the post-print processing system and for the further transmission of corresponding information to the joint control unit. Following the determination, the position of each individual device is managed in the joint control unit and this process is completed once the last discrete signal is received via the first data processing network. A method of this type also permits detecting and avoiding error sources, for example interruptions in the network.

According to a different variant of the inventive method, information relating to the respective type of individual device is also transmitted via at least one of the data telegrams, transmitted by the individual devices to the joint control unit. This method provides a simple, cost-effective variant for further transmitting information relating to the type of the respective individual device.

Corresponding to a further embodiment of the inventive method, at least one individual device in the post-print processing system is exchanged for a different individual device, wherein along with removing the at least one individual device, the two data processing networks are interrupted and are then closed again once the at least one individual device has been replaced with another individual device. The method and the device for controlling the post-print processing system can thus be adapted easily to successively following different production orders which require a replacement of individual devices.

In accordance with a different variant of the inventive method, at least one individual device of the post-print processing system is removed without being replaced and the two data processing networks, interrupted as a result, are then closed again. Thus, the method and the device for controlling the post-print processing system and, in particular its control can be adapted easily and securely to those successively following, different production orders, for which at least one individual device must be removed from the post-print processing system.

According to yet another variant of the inventive method, a check is made to determine whether the last discrete signal arrives in the joint control unit and, if not, the post-print processing system is not started or is stopped. With this measure, it is possible to easily and cost-effectively ensure that the post-print processing system does not attempt to produce additional printed products during interferences.

Another variant of the inventive method provides for triggering a time monitoring with a preset target time, along with the transmitting, or after the transmitting, of the first discrete signal to the post-print processing system, and the post-print processing system is not started or is stopped if the last discrete signal does not arrive within the preset target time in the joint control unit. This measure advantageously permits an even faster shutting down of the post-print processing system in case of interferences.

According to another aspect of the invention there is provided an apparatus for adapting a post-print processing system for producing printed products, to successively following, different production orders, the post-print processing system including a plurality of replaceable individual devices, arranged successively in a row and/or parallel, wherein in one embodiment the apparatus comprises: a data processing network including a first and a second data processing network; and a joint control unit supplied via the data processing network with information of the type of individual devices arranged in the post-print processing system and the respective position of said devices in the post-print processing system to activate the individual devices based on said information; wherein the first and the second data processing network are adapted for connecting the respective individual devices to the joint control unit, wherein the first data processing network comprises a ring circuit and information relating to the position of the individual devices in the post-print processing system is determined based on the respective position of the individual devices in the first data processing network, the second data processing network being operative to respectively transmit a data telegram corresponding to the position of the respective individual device from the individual devices to the joint control unit.

Owing to the arrangement and the use of the first data processing network for determining the information relating to the respective position of the individual devices in the post-print processing system, no additional electronic components are used for the sensor technology, nor does it require a manual input. An apparatus can thus be used which is relatively cheap, simple and less prone to errors and malfunctions.

According to one embodiment of the apparatus according to the invention, the first data processing network is operative for connecting a last individual device of the post-print processing system to the joint control unit.

As a result of the additional connection, the joint control unit can check whether the information received by the control device via the first data network and relating to the last individual device coincides with knowledge derived from information received via the second data network on the number of replaceable individual devices arranged in the post-print processing system. If not, corresponding measures can be taken, for example a check by a machine operator of the control apparatus, including the individual devices. Since even the last individual device of the post-print processing system has been identified by the joint control unit, following the information received via the first data network, it can furthermore be ensured that corresponding data telegrams for activating the individual devices are transmitted only following a complete identification of all replaceable individual devices currently installed in the post-print processing system. High quality and safety requirements can thus be met with this embodiment of the apparatus according to the invention.

Corresponding to another embodiment of the apparatus according to the invention, the first data processing network comprises for each individual device of the post-print processing system at least one signal input and at least one signal output, as well as a signal receiving and generating element that is connected to the second data processing network. In the same way, the joint control unit is provided with at least one signal input and at least one signal output, as well as with a central computer that is connected to the first and second data processing network. A simple and cost-effective solution can respectively be realized with these conventional electronic components.

According to a different embodiment of the inventive apparatus, the first data processing network has branches leading to a second signal input of the replaceable individual devices. As a result, malfunctions and errors in the individual devices or interruptions in the further transmission of signals can be localized precisely in the joint control unit since in that case the information is not transmitted further via a defective individual device and/or an interrupted connection of the first data processing device.

Corresponding to a different embodiment of the inventive apparatus, the first data processing network is configured as a daisy-chain network. With such a wiring circuit, known from the electronic and computer industry, conflicts and error functions in the signal processing can furthermore be prevented advantageously.

According to yet another embodiment of the apparatus according to the invention, the second data processing network is designed as ETHERNET POWERLINK, an open protocol managed by the Ethernet POWERLINK Standardization Group (EPSG). As a result, a known, standardized and thus cost-effective solution can be utilized.

According to a further aspect of the invention there is provided a post-print processing system including the adapting apparatus as previously described and the plurality of replaceable individual devices which are connected via the first and the second data processing network to the joint control unit. A post-print processing system of this type does not require additional electronic components for sensor technology or a manual input of the position. Thus, a relatively simple, cheap post-print processing system can be used which is not prone to many errors or malfunctions.

According to another embodiment of the inventive post-print processing system, there is provided at least one fixedly installed individual device, in addition to the replaceable individual devices, which is only connected via the second data processing network to the joint control unit. As a result, a post-print processing system of this type can be advantageously configured with replaceable as well as fixedly installed individual devices.

The post-print processing system according to a different embodiment is configured as a gathering and wire-stitching machine and its individual devices are embodied as feeders for the gathering and wire-stitching machine. Even though this embodiment relates to a specific configuration of the post-print processing system, the device according to the invention can also be used with other post-print processing systems, for example with adhesive binders or collating machines.

Of course, a control method and a control apparatus of this type can also be used for post-print processing systems that process successively following print orders but do not require replacing individual devices. In that case, a diagnosis of the individual devices and the corresponding connections can advantageously take place via the data processing networks.

### BRIEF DESCRIPTION OF THE DRAWINGS

The invention is described in the following with the aid of an exemplary embodiment, which shows in:

FIG. 1 is a schematic representation of a post-print processing system embodied as a gathering and wire-stitching machine, provided with the inventive control apparatus.

### DETAILED DESCRIPTION OF THE INVENTION

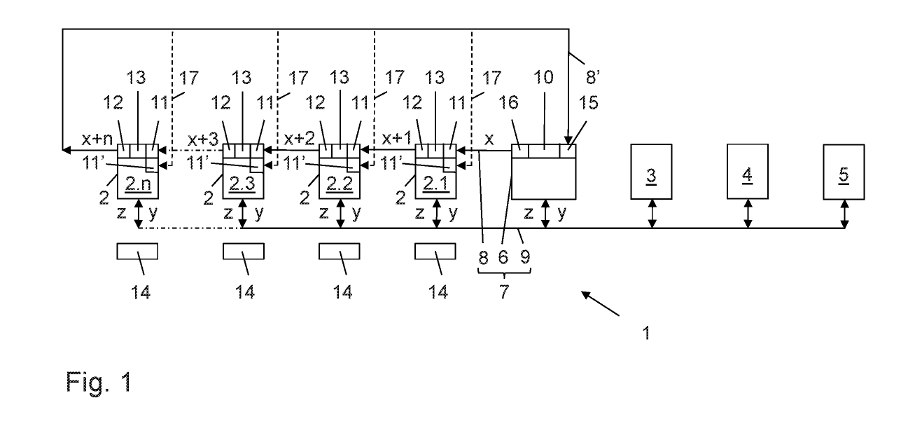

FIG. 1 shows a schematic representation of a post-print processing system 1, for example embodied as gathering and wire-stitching machine, comprising a number n of replaceable individual devices 2, which are arranged one after another in a row and are respectively embodied as printed sheet feeders, a fixedly installed wire-stitching machine 3, an also fixedly installed cutting machine 4, embodied as three-side trimmer, and at least one also fixedly installed transporting device 5 that moves through the post-print processing system 1 for conveying printed sheets (not shown) to be processed in the post-print processing system 1. In addition, the post-print processing system 1 comprises a joint computer-based control unit 6 for the aforementioned components which are respectively connected to the joint control unit 6. Of course, at least one additional control device for individual or several of these components can also be arranged. In the following, the printed sheet feeders are simply called feeders 2.1, 2.2, 2.3 . . . 2.n.

An apparatus 7 for controlling the gathering and wire-stitching machine is provided in addition to the joint control unit 6 with a first data processing network 8, as well as a second data processing network 9, wherein both networks are arranged between the joint control unit 6 of the gathering and wire-stitching machine and its replaceable feeders 2.1, 2.2, 2.3 . . . 2.n. The first data processing network 8 is embodied as ring a circuit 8′, so that the joint control unit 6 is connected via the first data processing network 8 directly to a first feeder 2.1 and a last feeder 2.n of this data processing network 8. In addition, the joint control unit 6 is also connected via the second data processing network 9 to the wire-stitching machine 3, the trimmer 4 and the transporting device 5. The first data processing network 8 can advantageously be configured as a daisy-chain network and the second data processing network 9 can be embodied as an Ethernet Powerlink. Even though for a better understanding the wires for the two data processing networks 8 and 9 are shown separately in FIG. 1, these individual wires generally are arranged jointly in a single cable sleeve, not shown herein.

The replaceable devices 2, embodied as feeders 2.1, 2.2, 2.3 . . . 2.n, are arranged successively in a row in the first data processing network 8 as well as in the post-print processing system 1 and are respectively provided with at least one signal input 11 and at least one signal output 12 for the first data processing network 8, as well as with a signal receiving and generating element 13, e.g. embodied as a remote IO, that cooperates with both data processing networks 8, 9. In other words, the first data processing network 8 for each feeder 2.1, 2.2, 2.3, . . . , 2.n of the gathering and wire-stitching machine is provided with at least one signal input 11 and at least one signal output 12, as well as a signal receiving and generating element 13 that is connected to the second data processing network 9. A positioning location 14 embodied as sub-structure is respectively provided for each feeder 2.1, 2.2, 2.3 . . . 2.n, on which the feeders 2.1, 2.2, 2.3 . . . 2.n are arranged so as to be replaceable. The joint control unit 6 also comprises at least one signal input 15 and at least one signal output 16, as well as a central computer 10 that is connected to the first and the second data processing network 8, 9. Finally, the first data processing network 8 comprises branches 17 to a second signal input 11′ of the replaceable individual devices 2 which, in turn, are connected via the second data processing network 9 to the joint control unit 6.

The gathering and wire-stitching machine shown in FIG. 1 is used in a manner known per se to produce booklets, magazines and similar printed products composed of a number of folded sheets and bound along the spine. For this, respectively one sheet is pulled for example with the aid of the feeders 2.1, 2.2, 2.3 . . . 2.n from stacks made available in stacking bins (not shown herein) of folded sheets that are identical per stack but differ from stack to stack and/or from feeder to feeder. The sheets are opened and deposited in a synchronized, clocked operation on a transport device 5, embodied as saddle-shaped gathering chain. As a result of the continuous transport of the printed sheets with the aid of the gathering chain, the different sheets are gathered and deposited straddling, one above the other. Following this, the gathered printed sheets are stapled with wire staples in the wire-stitching machine 3 along the folding region, and are finally trimmed or cut in the trimmer 4 along the remaining three sides to the required format. Accordingly, the production of printed products as shown in FIG. 1 takes place from left to right. Alternative to an arrangement in a row, the feeders 2.1, 2.2, 2.3 . . . 2.n can also be arranged parallel in the gathering and wire-stitching machine, or additional individual feeders can be arranged parallel to the individual feeders arranged in a row. However, the feeders 2.1, 2.2, 2.3 . . . 2.n in the first data processing network 8 are always arranged in a ring circuit 8′, meaning successively in a row.

Advertising materials such as booklets, invitations, sweepstakes, but also supplemental products such as goods samples, cards or compact discs (CDs) can also be provided when using special feeders, which can furthermore be intended for a specific recipient circle but also for a specific person, meaning they can be individualized.

Depending on the sequence of the actual production orders, the feeders 2.1, 2.2, 2.3 . . . 2.n can also be displaced, as needed, from one location 14 to another one, for example with the aid of a displacement carriage that is not shown herein. In the same way, the feeders 2.1, 2.2, 2.3 . . . 2.n can also be removed from the gathering and wire-stitching machine or can be added on empty locations 14. In this way, different printed products can be produced successively.

Following the start-up of the gathering and wire-stitching machine and upon request from the joint control unit 6, the feeders 2.1, 2.2, 2.3 . . . 2.n installed therein respectively transmit a first data telegram y for the identification of the respective feeders 2.1, 2.2, 2.3 . . . 2.n via the second data processing network 9 to the joint control unit 6. A data telegram of this type contains at least one target identification number (ID) and at least one data packet by means of which the respective feeder 2.1, 2.2, 2.3 . . . 2.n discloses its existence in the gathering and wire-stitching machine. In addition, a data packet can also contain information on the type of the respective feeder 2.1, 2.2, 2.3 . . . 2.n.

After receiving these data telegrams y, the joint control unit 6 manages each feeder 2.1, 2.2, 2.3 . . . 2.n in the central computer 10 and transmits a first discrete signal x, for example a 24V signal, from its signal output 16 via the first data processing network 8 to a feeder 2.1 that is located in a first position in the first data processing network 8. The first discrete signal x is received at the signal input 11 of this feeder 2.1 and is detected with its signal receiving and generating element 13. This element subsequently generates a second data telegram y for confirming the receipt of the first discrete signal x and transmits this second data telegram y via the second data processing network 9 to the joint control unit 6. If not transmitted earlier, information of the type of the first feeder 2.1 can also be transmitted along with this second data telegram y. As a result of the second data telegram y, the joint control unit 6 detects the position of the feeder 2.1 and transmits via the second data processing network 9 a third data telegram z to the first feeder 2.1, which has now been identified with respect to its position in the gathering and wire-stitching machine and, if applicable, also with respect to the type. Following this, the signal receiving and generating element 12 of the first feeder 2.1 generates a second discrete signal x+1 and transmits this signal via its signal output 12 and the first data processing network 8 to the signal input 11 of the subsequently arranged feeder 2.2. The signal receiving and generating element 13 of said feeder then generates an additional data telegram y for confirming the receipt of the second discrete signal x+1 and transmits this data telegram y via the second data processing network 9 to the joint control unit 6.

The described action is repeated for all other feeders 2.2, 2.3 . . . , arranged successively in a row, of the gathering and wire-stitching machine. In the process, an additional discrete signal x+2, x+3, . . . is respectively generated and is transmitted via the first data processing network 8 to a following feeder 2.3, . . . of the gathering and wire-stitching machine. The signal receiving and generating element 13 of each successively arranged feeder 2.3, ..., in turn, generates a data telegram y, based on which it is identified in the central computer 10 of the joint control unit 6 of the gathering and wire-stitching machine. In this way, all feeders 2.1, 2.2, 2.3 . . . 2.n of the gathering and wire-stitching machine are identified with respect to their position. The signal receiving and generating element 13 of the feeder 2.n, located at the last position in the first data processing network 8, generates a last discrete signal x+n, corresponding to the n^{th} position of this feeder 2.n, and then transmits this signal x+n via its signal output 12 and via the first data processing network 8 embodied as ring circuit 8′ to the signal input 15 of the joint control unit 6.

Based on the evaluation of the last discrete signal x+n, received via the first data processing network 8, meaning the information relating to a last individual device 2 of the post-print processing system 1, as well as the data telegrams y received from the second data processing network 9 and the identification realized therewith of even the last feeder 2.n, the joint control unit 6 triggers the activation of the feeders 2.1, 2.2, 2.3 . . . 2.n of the gathering and wire-stitching machine with the aid of additional data telegrams z and via the second data processing network 9.

In addition, the last discrete signal x+n, meaning the information relating to the last individual device 2 of the post-print processing system 1, can be branched off from the first data processing network 8 via the branches 17, can be transmitted further to the individual devices 2 and can be transmitted by these devices via the second data transmission network 9 to the joint control unit 6. If the branched off information does not arrive at the joint control unit 6, the joint control unit 6 can precisely localize errors or malfunctions in the individual devices 2 or interruptions in the further transmission of information.

With this method, the information relating to the position of the feeders 2.1, 2.2, 2.3 . . . 2.n in the gathering and wire-stitching machine can thus be determined based on their respective position in the data processing network 8 embodied as ring circuit 8′. For this, a corresponding data telegram y is transmitted by the feeders 2.1, 2.2, 2.3 . . . 2.n via the second data processing network 9 to the joint control unit 6. The information relating to the number n of feeders 2.1, 2.2, 2.3 . . . 2.n is transmitted via the discrete signal x+n of the signal receiving and generating element 13 of the feeder 2.n, located in the last position of the first data processing network 8, via the first data processing network 8 to the joint control unit 6. The transmission of information relating to the type of feeders 2.1, 2.2, 2.3 . . . 2.n to the joint control unit 6 also takes place via the data telegrams y and the second data processing network 9.

For reasons of safety, a check is made to determine whether the last discrete signal x+n arrives in the joint control unit 6 and, if not, the gathering and wire-stitching machine is not started or is stopped. Alternatively, a time monitoring with a preset target time can be triggered along with, or following, the transmission of the first discrete signal x to the gathering and wire-stitching machine, and this machine either not be started or stopped if the last discrete signal x+n does not arrive within this preset target time in the joint control unit 6.

When replacing at least one feeder 2.1, 2.2, 2.3 . . . 2.n of the gathering and wire-stitching machine with another feeder 2.1, 2.2, 2.3 . . . 2.n, the two data processing networks 8, 9 are temporarily interrupted during the removal of the at least one feeder 2.1, 2.2, 2.3 . . . 2.n and are closed again once the new feeder 2.1, 2.2, 2.3 . . . 2.n has been installed in the positioning location 14, meaning on the feeder substructure.

On the other hand, if at least one feeder 2.1, 2.2, 2.3 . . . 2.n of the gathering and wire-stitching machine is removed without replacement, a free positioning location 14 is created for which the two interrupted data processing networks 8, 9 are closed once more, for example through installing a signal receiving and generating element 13. Of course, a feeder 2.1, 2.2, 2.3 . . . 2.n can also be installed in the free positioning location 14. For this, the previously installed signal and receiving element 13 can be removed again and the interrupted data processing networks 8, 9 closed again through installing the new feeder 2.1, 2.2, 2.3 . . . 2.n.

As a result of configuring the feeders 2.1, 2.2, 2.3 . . . 2.n with a signal input 11 and a signal output 12, as well as a signal receiving and generating element 13, the substructure of the feeders can advantageously be configured without electronic hardware.

It will be understood that the above description of the present invention is susceptible to various modifications, changes and adaptations, and that the same are intended to be comprehended within the meaning and range of equivalents of the appended claims.

What is claimed is:

1. A method for controlling a post-print processing system for producing printed products, said system comprising a plurality of replaceable individual devices which are arranged one after another in a row and/or parallel and are connected to a joint control unit for adapting the system to successively following different production orders, the method comprising:
supplying the joint control unit with information relating to the type and position of the individual devices in the post-print processing system and activating the individual devices based on said information;
determining the information relating to the position of the individual devices in the post-print processing system based on the position of the individual devices in a first data processing network, comprising a ring circuit; and
sending out from the individual devices a data telegram corresponding to the position of the respective individual devices via a second data processing network to the joint control unit.

2. The method according to claim 1, wherein the determining includes determining the position of the individual devices in the post-print processing system by the joint control unit.

3. The method according to claim 1, wherein the supplying includes transmitting information relating to a last individual device of the post-print processing system via the first data processing network to the joint control unit and activating the individual devices only after this information is received.

4. The method according to claim 3, wherein the supplying further includes branching off the information relating to the last individual device of the post-print processing system from the first data processing network, then transmitting the branched off information to the individual devices and then transmitting the information relating to the last individual device from the individual devices to the joint control unit via the second data processing network.

5. The method according to claim 1, wherein the method includes an operation, comprising steps a) to e) as follows:
a) following a start-up of the post-print processing system, transmitting respectively from the individual devices installed in the post-print processing system, upon request from the joint control unit, a first data telegram for the identification of the individual devices via the second data processing network to the joint control unit;
b) subsequently transmitting a first discrete signal from the joint control unit via the first data processing network to a first individual device that is in a first position in the data processing network;
c) detecting the first discrete signal by the first individual device and subsequently transmitting via the second data processing network a second data telegram to the joint control unit to confirm receipt of the first discrete signal;
d) detecting by the joint control unit the position of the first individual device based on the second data telegram and then transmitting a third data telegram to the first individual device; and
e) generating by the first individual device a second discrete signal as a result of the third data telegram and then transmitting the second discrete signal via the first data processing network to a following individual device;
repeating said operation for all individual devices, arranged successively in a row, of the post-print processing system, including generating respectively an additional discrete signal and transmitting the respective additional discrete signal via the first data processing network to a following individual device, and generating by the individual device located in a last position in the first data processing network a last discrete signal, corresponding to an n^{th} position for the last individual device, and transmitting the last discrete signal via the first data processing network to the joint control unit; and
after receiving and evaluating the last discrete signal by the joint control unit, triggering by the joint control unit the activation of the individual devices with additional data telegrams via the second data processing network.

6. The method according to claim 5, including transmitting by the individual devices information relating to a type of the respective individual device to the joint control unit together with respectively at least one of the data telegrams transmitted by the individual devices.

7. The method according to claim 1, wherein at least one individual device of the post-print processing system is replaced with another individual device, wherein upon removal of the at least one individual device, the two data processing networks are interrupted and are then closed again once the at least one individual device has been exchanged for another individual device.

8. The method according to claim 1, wherein at least one individual device of the post-print processing system is removed without being replaced and that the data processing networks, which are interrupted in the process, are then closed again.

9. The method according to claim 5, wherein the arrival of the last discrete signal is checked in the joint control unit and, if not, the post-print processing system is not started or is stopped.

10. The method according to the claim 5, wherein along with the transmission, or following the transmission, of the first discrete signal to the post-print processing system, a time monitoring with a preset target time is triggered and the post-print processing system is not started or is stopped if the last discrete signal does not arrive during the preset target time in the joint control unit.

11. An apparatus for adapting a post-print processing system for producing printed products, to successively following, different production orders, the post-print processing system including a plurality of replaceable individual devices, arranged successively in a row and/or parallel, the apparatus comprising:
a data processing network including a first and a second data processing network;
a joint control unit supplied via the data processing network with information of the type of individual devices arranged in the post-print processing system and the respective position of said devices in the post-print processing system to activate the individual devices based on said information;
wherein the first and the second data processing network are adapted and operative for connecting the respective individual devices to the joint control unit, wherein the first data processing network comprises a ring circuit and information relating to the position of the individual devices in the post-print processing system is determined based on the respective position of the individual devices in the first data processing network, the second data processing network being operative to respectively transmit a data telegram corresponding to the position of the respective individual device from the individual devices to the joint control unit.

12. The apparatus according to claim 11, wherein the first data processing network is operative for connecting a last individual device of the post-print processing system to the joint control unit.

13. The apparatus according to claim 11, wherein the first data processing network comprises for each replaceable individual device of the post-print processing system at least one signal input and at least one signal output, as well as a signal receiving and generating element that is connected to the second data processing network.

14. The apparatus according to claim 13, wherein the first data processing network includes branches leading to a second signal input of the replaceable individual devices.

15. The apparatus according to claim 11, wherein the joint control unit comprises at least one signal input and at least one signal output, and a central computer that is connected to the first and the second data processing network.

16. The apparatus according to claim 11, wherein the first data processing network comprises a daisy-chain network.

17. The apparatus according to claim 11, wherein the second data processing network comprises an ETHERNET POWERLINK.

18. A post-print processing system comprising, the apparatus according to claim 11 and the plurality of replaceable individual devices which are connected via the first and the second data processing networks to the joint control unit.

19. The post-print processing system according to claim 18, wherein in addition to the replaceable individual devices, said post-print processing system comprises at least one fixedly installed individual device which is only connected via the second data processing network to the joint control unit.

20. The post-print processing system according to claim 18, wherein the post-print processing system comprises a gathering and wire-stitching machine and the replaceable individual devices comprise feeders for the gathering and wire-stitching machine.
